(19) United States
(12) Patent Application Publication
(10) Pub. No.: US 2014/0002048 A1
(43) Pub. Date: Jan. 2, 2014

(54) VOLTAGE BALANCING CONTROL METHOD FOR MODULAR MULTILEVEL CONVERTER

(71) Applicants: Hui Pang, Beijing (CN); Zhiyuan He, Beijing (CN); Yan Zhao, Beijing (CN); Chunming Yuan, Beijing (CN); Dong Liu, Beijing (CN); Wenjin Li, Beijing (CN)

(72) Inventors: Hui Pang, Beijing (CN); Zhiyuan He, Beijing (CN); Yan Zhao, Beijing (CN); Chunming Yuan, Beijing (CN); Dong Liu, Beijing (CN); Wenjin Li, Beijing (CN)

(73) Assignee: CHINA ELECTRIC POWER RESEARCH INSTITUTE, Beijing (CN)

(21) Appl. No.: 14/005,266

(22) PCT Filed: Oct. 31, 2011
(86) PCT No.: PCT/CN11/01813

§ 371 Date: Sep. 15, 2013

(30) Foreign Application Priority Data
Mar. 21, 2011 (CN) 201110067984.1

(51) Int. Cl. H02M 11/00

(52) U.S. Cl. CPC H02M 11/00
USPC 323/304

(57) ABSTRACT

The present invention relates to Voltage balancing control method for modular multilevel converter is characterized that, it includes some steps as follows:

1) Determine the leg current direction is positive or negative;

2) Find out the highest sub module on output state whose capacitor voltage amplitude is the maximum, and find out that on bypass state whose capacitor voltage amplitude is the minimum;

3) Determine whether the sub module inputs or bypass operation; this method avoided switching arbitrariness of the sub module, and decreased the switching frequency of the sub module. The capacitor voltage balancing control of the sub module proposed by the method is more suitable to be applied in the field of high voltage and large capacity converter that has large numbers of sub modules.

### RELATED APPLICATIONS

This application is a United States National Stage Application filed under 35 U.S.0 371 of PCT Patent Application Serial No. PCT/CN2011/001813, filed Oct. 31, 2011, which claims the benefit of Chinese Patent Application Serial No. 201110067984.1, filed on Mar. 21, 2011, the disclosure of all of which are hereby incorporated by reference in their entirety.

### FIELD OF THE INVENTION

The invention relates to control method, in particular, relates to a voltage balancing control of converter.

### BACKGROUND OF THE INVENTION

In modular multilevel converter legs, charge and discharge, loss and capacitance difference of the sub modules will cause capacitor voltage imbalance, and harm the normal work of the converter. in order to ensure the normal work of the modular multilevel converter, the traditional capacitor voltage balancing control method of the sub module is:

(1) monitor sub module capacitor voltage value rapid and order; (2) monitor the current direction of each leg, and determine the charge or discharge for legs sub modules; (3) when triggering the control action, if the legs current charge the sub module, input corresponding number of sub modules according to the sequence from low capacitor voltage to high; if the legs current discharge the sub module, input corresponding number of sub modules according the reverse order.

However, the traditional method has some badly problems:

First of all, the method doesn't consider the initial sub module switching state. When each level change, the sub module switching state has great randomness, there may be large quantum sub modules switching states needs to change. If sub modules are removed in the phase unit, the same number of sub modules must be input in order to maintain the total DC voltage constantly; Due to the difference of the switching characteristics of power electronic devices and dead time, the input time and the removal time of the different sub modules may not be at the same time. This will cause the total DC voltage fluctuation. The more sub modules switching state needs to change, the fiercer the total DC voltage fluctuates.

Secondly, the power electronic devices have higher switching frequency and switching loss because of the higher switching frequency of the sub modules, and this reduces the HVDC transmission efficiency of the modular multilevel converter.

Furthermore, because there are lots of leg sub modules in the modular multilevel converter HVDC transmission system, it takes much more time to monitor and schedule the sub modules capacitance voltage, this will introduce a large delay in triggering control, and reduce the velocity of the converter tracking the modulation wave.

### BRIEF DESCRIPTION OF THE DRAWINGS

FIG. 1 is the input state operation principle diagram of the voltage balancing control of modular multilevel converter provided by the present invention;

FIG. 2 is the bypass state operation principle diagram of the voltage balancing control of modular multilevel converter provided by the present invention;

FIG. 3 is structure schematic diagram of MCC (modular multilevel converter) of the voltage balancing control of modular multilevel converter provided by the present invention;

In these figures:

T1. IGBT module; T2. IGBT D1. fly-wheel diode; D2. fly-wheel diode; C. capacitor.

### SUMMARY OF THE INVENTION

The aim of the invention is, in view of the defects existing in the prior art, to provide Voltage balancing control method for modular multilevel converter. The method combines leg current direction and the initial work state of the sub module to adjust the work state of sub modules reasonably, and reduce the switching frequency of power devices.

Voltage balancing control method for modular multilevel converter provided by the invention is characterized by including some steps as follows:

1) determine the leg current direction is positive or negative;

2) find out the highest sub module on output state whose capacitor voltage amplitude is the maximum, and find out that on bypass state whose capacitor voltage amplitude is the minimum;

3) determine whether the sub module inputs or bypass operation.

First technical voltage balancing control of modular multilevel converter provided by the invention is preferred: If the leg current direction is positive, the leg current will charge the sub module capacitor on output state. And then, find out the highest sub module on output state whose capacitor voltage amplitude is the maximum and that on bypass state whose capacitor voltage amplitude is the minimum at the same time;

Second technical voltage balancing control of modular multilevel converter provided by the invention is preferred: Under the premise of positive direction leg current, if leg level output increases, the bypass state of the sub module will be change into output state, and put into the capacitor voltage lowest sub module all of sub modules on the bypass state;

Under the premise of positive direction leg current, if leg level output decreases, the output state of the sub module will be change into bypass state, and bypass the capacitor voltage highest sub module all of sub modules on the output state.

Third technical voltage balancing control of modular multilevel converter provided by the invention is preferred: Under the premise of positive direction leg current, if there is no need to put into or bypass the sub module, determine the capacitor voltage maximum of the sub modules on output state whether more than given limited value or not, if it is greater than the limited value, exchange the state of the sub module with the bypass state of the sub module whose capacitor voltage amplitude is the minimum. If not, it is no need to carry out above operation.

Fourth technical voltage balancing control of modular multilevel converter provided by the invention is preferred: If the leg current direction is negative, the leg current will discharge the sub module capacitor on output state. And then, find out the highest sub module on output state whose capacitor voltage amplitude is the minimum and that on bypass state whose capacitor voltage amplitude is the maximum at the same time.

Fifth technical voltage balancing control of modular multilevel converter provided by the invention is preferred: Under the premise of negative direction leg current, if leg level output increases, the bypass state of the sub module will be change into output state, and put into the capacitor voltage highest sub module all of sub modules on the bypass state;

Under the premise of negative direction leg current, if leg level output decreases, the output state of the sub module will be change into bypass state, and bypass the capacitor voltage lowest sub module all of sub modules on the output state.

Sixth technical voltage balancing control of modular multilevel converter provided by the invention is preferred: Under the premise of positive direction leg current, if there is no need to put into or bypass the sub module, determine the capacitor voltage minimum of the sub modules on output state whether more than given limited value or not, if it is greater than the limited value, exchange the state of the sub module with the bypass state of the sub module whose capacitor voltage amplitude is the maximum. If not, it is no need to carry out above operation.

Seventh technical voltage balancing control of modular multilevel converter provided by the invention is preferred: wherein said put into is defined as that make one IGBT module of the sub modules conduction.

Eighth technical voltage balancing control of modular multilevel converter provided by the invention is preferred: wherein said IGBT module is upper IGBT module.

The above method is that:

If leg current charges the sub module, find out the highest sub module on output state whose capacitor voltage amplitude is the maximum and that on bypass state whose capacitor voltage amplitude is the minimum at the same time; if leg level output increases, put into the capacitor voltage lowest sub module all of sub modules on the bypass state; if leg level output decreases, bypass the capacitor voltage highest sub module all of sub modules on the output state; if leg level output doesn't change, determine the capacitor voltage maximum of the sub modules on output state whether more than given limited value or not, if it is greater than the limited value, exchange the state of the sub module with the bypass state of the sub module whose capacitor voltage amplitude is the minimum. If not, keep each sub module work state.

If leg current discharges the sub module, find out the highest sub module on output state whose capacitor voltage amplitude is the minimum and that on bypass state whose capacitor voltage amplitude is the maximum at the same time; if leg level output increases, put into the capacitor voltage highest sub module all of sub modules on the bypass state; if leg level output decreases, bypass the capacitor voltage lowest sub module all of sub modules on the output state; if leg level output doesn't change, determine the capacitor voltage minimum of the sub modules on output state whether more than given limited value or not, if it is greater than the limited value, exchange the state of the sub module with the bypass state of the sub module whose capacitor voltage amplitude is the maximum. If not, keep each sub module work state.

Compared with the prior art, Voltage balancing control method for modular multilevel converter provided by the present invention has the following advantages:

1. The method considered sub module initial switching state; when leg level output changes, it avoided switching arbitrariness of the sub module, and decreased the switching frequency of the sub module;

2. When the leg level output unchanged, it can ensure the capacitor voltage amplitude of the sub module in a certain range through changing the sub module work state;

3. When the sub module state transitions, it only search the sub modules whose capacitor voltage amplitude is the maximum and minimum, this reduce calculated load of the leg controller effectively, and improve the control cycle of the leg controller, and reduce the delay time of the trigger control, and accelerate tracking speed for signal modulation of the leg controller, and improve the operation performance of the converter;

4. The capacitor voltage balancing control of the sub module proposed by the method is more suitable to be applied in the field of high voltage and large capacity converter that has large numbers of sub modules.

### DETAILED DESCRIPTION OF EMBODIMENTS

The detail of the embodiments is described as below incorporated with the figures by way of cross-reference for Voltage balancing control method for modular multilevel converter provided by the present invention.

### Embodiment 1

The voltage balancing control method of modular multilevel converter of the embodiment includes some steps as below;

1) Determine the leg current direction is positive or negative;

2) Find out the highest sub module on output state whose capacitor voltage amplitude is the maximum, and find out that on bypass state whose capacitor voltage amplitude is the minimum;

3) Determine whether the sub module inputs or bypass operation.

The specific operation is as follows:

Firstly, determine the leg current direction;

If the leg current direction is positive, the leg current will charge the sub module capacitor on output state. And then, find out the highest sub module on output state whose capacitor voltage amplitude is the maximum and that on bypass state whose capacitor voltage amplitude is the minimum at the same time;

Under the premise of positive direction leg current, if leg level output increases, the bypass state of the sub module will be change into output state, and put into the capacitor voltage lowest sub module all of sub modules on the bypass state.

Under the premise of positive direction leg current, if leg level output decreases, the output state of the sub module will be change into bypass state, and bypass the capacitor voltage highest sub module all of sub modules on the output state.

Under the premise of positive direction leg current, if there is no need to put into or bypass the sub module, determine the capacitor voltage maximum of the sub modules on output state whether more than given limited value or not, if it is greater than the limited value, exchange the state of the sub module with the bypass state of the sub module whose capacitor voltage amplitude is the minimum. If not, it is no need to carry out above operation.

If the leg current direction is negative, the leg current will discharge the sub module capacitor on output state. And then, find out the highest sub module on output state whose capacitor voltage amplitude is the minimum and that on bypass state whose capacitor voltage amplitude is the maximum at the same time;

Under the premise of negative direction leg current, if leg level output increases, the bypass state of the sub module will be change into output state, and put into the capacitor voltage highest sub module all of sub modules on the bypass state.

Under the premise of negative direction leg current, if leg level output decreases, the output state of the sub module will be change into bypass state, and bypass the capacitor voltage lowest sub module all of sub modules on the output state.

Under the premise of positive direction leg current, if there is no need to put into or bypass the sub module, determine the capacitor voltage minimum of the sub modules on output state whether more than given limited value or not, if it is greater than the limited value, exchange the state of the sub module with the bypass state of the sub module whose capacitor voltage amplitude is the maximum. If not, it is no need to carry out above operation.

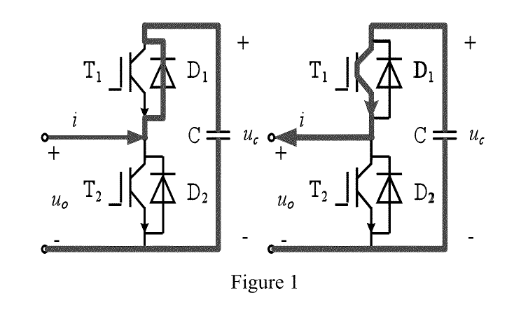

Put into is defined as that make one IGBT of the sub modules conduction, as FIG. 1 shown, in FIG. 1 the upper IGBT module is conduction.

Modular multilevel converter is a new type multilevel voltage source converter, its operation structure is showed in FIG. 1, the converter can output very high level number in the AC side, it is suitable for high voltage and high power transform domain.

In operation, by in the, sub module presents different working state by controlling the switch turn-on and turn off of the sub modules. When sub module T1 is on and T2 off, leg current charge or discharge to the sub module capacitor, the sub module is on output state. When sub module T1 is off and T2 on, the sub module capacitor is bypassed, the sub module is on the bypass state. Current positive direction is showed in FIG. 1, if the leg current is positive, the capacitor of the sub module on the output state is charged, conversely, the capacitor of the sub module on the output state is discharged.

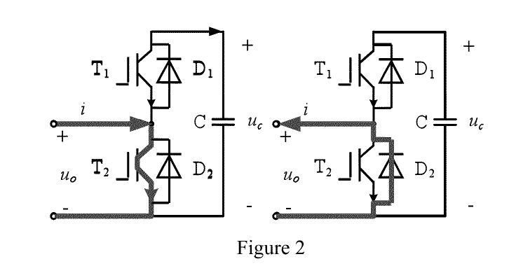

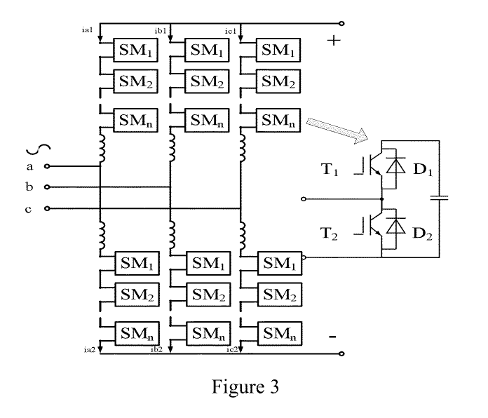

As shown in FIG. 3, modular multilevel converters (MMC) composed of six legs, each leg consists of n sub modules in series, and the structure of each sub module is showed in FIG. 1, during normal operation, the leg controller control working state of each sub module of legs according to the MMC modulation algorithm. During normal operation, each MMC sub module exists two working states, as FIG. 1 and FIG. 2 shown.

Output state: T1 (the upper leg IGBT of the sub module) is on, T2 (the lower leg IGBT of the sub module) is off, On this state, when the current i flows to sub module interior (as FIG. 1 left shown), current will flow into the capacitor through diode D1, and the capacitor is charged; when the current i flows out of sub modules (as the right shown in FIG. 1), the current will discharge capacitor through the T1. No matter what direction the current i flows, the output end voltage of sub module always is equal to the capacitor voltage, i.e. uₒ=u_{c}. Therefore, the working state is an output state of the sub module circuit.

Bypass state: T1 (the upper leg IGBT of the sub module) is off, T2 (the lower leg IGBT of the sub module) is on, On this state, when the current i flows to sub module interior (as FIG. 2 left shown), current will flow through T2; when the current i flows out of sub modules, the current will flow through diode D2. No matter what direction the current i flows, the output voltage of sub module is always equal to zero, i.e. uₒ=0.

Assuming that the MMC current is positive direction, as shown in FIG. 3, when the leg current is positive, the capacitor of sub module on output state will be charged, and the capacitor voltage amplitude will increase; when the leg current is negative, the capacitor of sub module on output state will be discharged, and the capacitor voltage amplitude will decrease.

During normal operation, the time of each sub module that is on output state is different, also the current amplitude of leg currents are different. So the capacitor voltage amplitude of each sub module will vary. This will cause the capacitor voltage imbalance of MMC sub modules, some capacitors voltage will raise incessant, and some will reduce last, so the MMC cannot be sustained working stably.

The voltage balancing control of MMC can ensure the capacitor voltage of each module be maintained in a certain range during MMC normal operation, and ensure MMC continuous and reliable operation.

At last, in this description of the embodiments, we have detail describe the present invention according to a particular example. The detail embodiment is one example of the invention but not the only one, so the person in this field must be understand that all the alternatives and other equal and/or similar examples are all within the range of the invention and they are all consistent with the spirits of this invention, are all protected by our claims.

What is claimed is:

1. A voltage balancing control method for modular multilevel converter is characterized that, it includes some steps as follows:
1) Determine the leg current direction is positive or negative;
2) Find out the highest sub module on output state whose capacitor voltage amplitude is the maximum, and find out that on bypass state whose capacitor voltage amplitude is the minimum;
3) Determine whether the sub module inputs or bypass operation.

2. The voltage balancing control method for modular multilevel converter according to claim 1, is characterized that:
If the leg current direction is positive, the leg current will charge the sub module capacitor on output state. And then, find out the highest sub module on output state whose capacitor voltage amplitude is the maximum and that on bypass state whose capacitor voltage amplitude is the minimum at the same time.

3. The voltage balancing control method for modular multilevel converter according to claim 2, is characterized that:
Under the premise of positive direction leg current, if leg level output increases, the bypass state of the sub module will be change into output state, and put into the capacitor voltage lowest sub module all of sub modules on the bypass state;
Under the premise of positive direction leg current, if leg level output decreases, the output state of the sub module will be change into bypass state, and bypass the capacitor voltage highest sub module all of sub modules on the output state.

4. The voltage balancing control method for modular multilevel converter according to claim 3, is characterized that:
Under the premise of positive direction leg current, if there is no need to put into or bypass the sub module, determine the capacitor voltage maximum of the sub modules on output state whether more than given limited value or not, if it is greater than the limited value, exchange the state of the sub module with the bypass state of the sub module whose capacitor voltage amplitude is the minimum. If not, it is no need to carry out above operation.

5. The voltage balancing control method for modular multilevel converter according to claim 1, is characterized that:
If the leg current direction is negative, the leg current will discharge the sub module capacitor on output state. And then, find out the highest sub module on output state whose capacitor voltage amplitude is the minimum and that on bypass state whose capacitor voltage amplitude is the maximum at the same time.

6. The voltage balancing control method for modular multilevel converter according to claim 1, is characterized that:
Under the premise of negative direction leg current, if leg level output increases, the bypass state of the sub module will be change into output state, and put into the capacitor voltage highest sub module all of sub modules on the bypass state;
Under the premise of negative direction leg current, if leg level output decreases, the output state of the sub module will be change into bypass state, and bypass the capacitor voltage lowest sub module all of sub modules on the output state.

7. The voltage balancing control method for modular multilevel converter according to claim 1, is characterized that:
Under the premise of positive direction leg current, if there is no need to put into or bypass the sub module, determine the capacitor voltage minimum of the sub modules on output state whether more than given limited value or not, if it is greater than the limited value, exchange the state of the sub module with the bypass state of the sub module whose capacitor voltage amplitude is the maximum. If not, it is no need to carry out above operation.

8. The voltage balancing control method for modular multilevel converter according to claim 1 or 3 or 6, is characterized that, wherein said put into is defined as that make one IGBT module of the sub modules conduction.

9. The voltage balancing control method for modular multilevel converter according to claim 8, is characterized that, wherein said IGBT module is an upper IGBT module.
